(19) United States
(12) Patent Application Publication
(10) Pub. No.: US 2026/0113566 A1
(43) Pub. Date: Apr. 23, 2026

(54) EARPHONES

(71) Applicant: SHENZHEN SHOKZ CO., LTD., Shenzhen (CN)

(72) Inventors: Wenbing ZHOU, Shenzhen (CN); Yujia HUANG, Shenzhen (CN); Hao KE, Shenzhen (CN); Henghao ZHANG, Shenzhen (CN); Fengyun LIAO, Shenzhen (CN); Xin QI, Shenzhen (CN)

(73) Assignee: SHENZHEN SHOKZ CO., LTD., Shenzhen (CN)

(21) Appl. No.: 19/424,074

(22) Filed: Dec. 17, 2025

Related U.S. Application Data
(63) Continuation of application No. PCT/CN2023/143681, filed on Dec. 29, 2023.

(51) Int. Cl. H04R 1/10

(52) U.S. Cl. CPC H04R 1/1075; H04R 1/1008

(57) ABSTRACT

The present disclosure provides an earphone. The earphone comprises a housing and at least one waterproof acoustic module. At least one accommodation cavity and at least one sound transmission hole are formed on an inner wall of the housing. The at least one sound transmission hole penetrates through the housing and communicates with the at least one accommodation cavity. Each of the at least one waterproof acoustic module comprises a communication hole and a waterproof assembly. The waterproof assembly is configured to prevent a liquid from entering an interior of the waterproof acoustic module through the communication hole. The at least one waterproof acoustic module is disposed in the at least one accommodation cavity and covers the at least one sound transmission hole to prevent the liquid from entering an internal space of the housing through the at least one sound transmission hole.

### CROSS-REFERENCE TO RELATED APPLICATIONS

This application is a Continuation of International Patent Application No. PCT/CN2023/143681, filed on Dec. 29, 2023, the entire contents of which are incorporated herein by reference.

### TECHNICAL FIELD

The present disclosure belongs to the technical field of electronic devices, and specifically relates to earphones.

### BACKGROUND

Earphones are typically provided with multiple acoustic sensors. When an earphone is used in outdoor or humid environments, liquids may easily penetrate the interior of the earphone through one or more sound transmission holes provided on the earphone. For example, during underwater activities such as swimming, water may enter the earphone via the sound transmission hole(s). Therefore, it is necessary to incorporate moisture-proof and waterproof designs into earphones intended for use in damp environments.

Since the sensitivity of the acoustic sensors may be affected during assembly into the earphone, and due to moisture-proof and liquid-proof requirements, the acoustic sensors must be sealed and installed within the earphone using a waterproof structure, making them difficult to disassemble and adjust. As a result, the sensitivity of the acoustic sensors is also difficult to adjust, making it hard to ensure that the sensitivity deviation among earphones of the same batch falls within an ideal tolerance range, thereby leading to a relatively low yield rate of earphones in the same batch.

Therefore, it is desirable to provide an earphone and an acoustic module for the earphone, having a structure that is waterproof and capable of solving the above problem of low yield rate of earphones in the same batch.

### SUMMARY

The present disclosure provides an earphone. The earphone comprises a housing and at least one waterproof acoustic module. At least one accommodation cavity and at least one sound transmission hole are formed on an inner wall of the housing. The at least one sound transmission hole penetrates through the housing and communicates with the at least one accommodation cavity. Each of the at least one waterproof acoustic module comprises a communication hole and a waterproof assembly. The waterproof assembly is configured to prevent a liquid from entering an interior of the waterproof acoustic module through the communication hole. The at least one waterproof acoustic module is disposed in the at least one accommodation cavity and covers the at least one sound transmission hole to prevent the liquid from entering an internal space of the housing through the at least one sound transmission hole.

In some embodiments, the at least one waterproof acoustic module comprises a first waterproof acoustic module and a second waterproof acoustic module, the at least one accommodation cavity comprises a first accommodation cavity and a second accommodation cavity, and the at least one sound transmission hole comprises a first sound transmission hole and a second sound transmission hole. The first waterproof acoustic module is disposed in the first accommodation cavity and covers the first sound transmission hole, and the second waterproof acoustic module is disposed in the second accommodation cavity and covers the second sound transmission hole

In some embodiments, the inner wall of the housing comprises a housing bottom wall and a housing side wall. The first accommodation cavity is provided on the housing bottom wall, the second accommodation cavity is provided on the housing side wall, and the first waterproof acoustic module and the second waterproof acoustic module are connected by a flexible circuit board.

In some embodiments, the first waterproof acoustic module comprises a first acoustic sensor, the second waterproof acoustic module comprises a second acoustic sensor, and the first acoustic sensor and the second acoustic sensor are microphones or speakers.

In some embodiments, the first waterproof acoustic module comprises a first circuit board and the second waterproof acoustic module comprises a second circuit board. The inner wall of the housing forms a first accommodation side wall of the first accommodation cavity and a second accommodation side wall of the second accommodation cavity. The first accommodation side wall is higher than an upper surface of the first circuit board, thereby forming a first accommodation space for accommodating a sealing material, and/or, the second accommodation side wall is higher than an upper surface of the second circuit board, thereby forming a second accommodation space for accommodating a sealing material.

In some embodiments, the first circuit board and the second circuit board are connected by a flexible circuit board.

In some embodiments, each of the at least one accommodation cavity corresponds to one waterproof acoustic module and comprises an accommodation side wall and an accommodation bottom wall, and each of the at least one sound transmission hole penetrates through the corresponding accommodation bottom wall to connect the internal space of the housing with an external space. Each of the at least one waterproof acoustic module comprises a base, the waterproof assembly, an acoustic assembly, and a circuit board. The base comprises a base side wall, a base bottom wall, and the communication hole. The base side wall and the base bottom wall form a base accommodation cavity, the communication hole penetrates through the base bottom wall and communicates with the base accommodation cavity, and the base is in sealed connection with the corresponding accommodation cavity. The waterproof assembly is disposed in the base accommodation cavity and covering the communication hole to prevent the liquid from entering the base accommodation cavity through the communication hole. The acoustic assembly comprises an acoustic sensor that is disposed on a side of the waterproof assembly away from the base bottom wall. The circuit board is located between the acoustic sensor and the waterproof assembly and mechanically connected to the acoustic sensor.

In some embodiments, the earphone further comprises a first sealing member and a second sealing member. The base bottom wall abuts against the accommodation bottom wall to form a first gap, and the base side wall and the accommodation side wall form a second gap. The first sealing member seals the first gap, and the second sealing member seals the second gap.

In some embodiments, the first sealing member is formed by providing a fluid sealing material into the first gap and curing the fluid sealing material, and/or, the second sealing member is formed by providing the fluid sealing material into the second gap and curing the fluid sealing material.

In some embodiments, the first sealing member is a pre-formed sealing gasket.

In some embodiments, a first limiting portion is provided on the base bottom wall circumferentially around the communication hole, a second limiting portion is provided on the accommodation bottom wall circumferentially around the sound transmission hole, and the first limiting portion and the second limiting portion engage with and abut against each other to form a third gap.

In some embodiments, the earphone further comprises a third sealing member for sealing the third gap. The third sealing member is formed by providing the fluid sealing material to the third gap and curing the fluid sealing material. The first limiting portion and the second limiting portion engage with and abut against each other to prevent the fluid sealing material from flowing into the sound transmission hole.

In some embodiments, the first limiting portion comprises a groove provided on the base and arranged circumferentially around the communication hole, and the second limiting portion comprises a corresponding protrusion provided on the accommodation bottom wall and arranged circumferentially around the sound transmission hole.

In some embodiments, the circuit board extends over a target segment of the accommodation side wall and is connected to a flexible circuit board. The target segment of the accommodation side wall has a smoother design compared to other portions of the accommodation side wall to reduce bending of the circuit board caused by the accommodation side wall.

In some embodiments, the target segment comprises a guiding opening formed on the accommodation side wall and an inclined guiding surface, and the guiding opening is connected to the inner wall of the housing via the guiding surface to support the circuit board.

In some embodiments, for each of the at least one sound transmission hole, an aperture of the sound transmission hole on the inner wall of the housing is less than or equal to an aperture of the sound transmission hole on an outer wall of the housing.

In some embodiments, a central axis of each of the at least one sound transmission hole is inclined relative to the accommodation bottom wall of the corresponding accommodation cavity.

As can be understood from the above technical solution, the earphone provided in the present disclosure adopts an installation structure for acoustic sensors with liquid-resistant effects. Since the sensitivity of the acoustic sensors may be affected during assembly into the earphone, and due to moisture-proof and liquid-proof requirements, the acoustic sensors must be sealed and installed within the earphone using a waterproof structure, making them difficult to disassemble and adjust. As a result, the sensitivity of the acoustic sensors is also difficult to adjust, making it hard to ensure that the sensitivity difference among a same batch of earphones falls within an ideal tolerance range, thereby leading to a relatively low yield rate of earphones in the same batch. In the present disclosure, the acoustic sensors and waterproof components are integrated into a pre-assembled acoustic module, which is then installed into the earphone. By selecting and adjusting the acoustic module according to predefined sensitivity differential requirements, the sensitivity differences among multiple acoustic sensors within the same earphone can be flexibly managed. This approach ensures that the sensitivity differences among earphones from the same production batch remains within an ideal range, thereby guaranteeing a high yield rate.

Additional features of the earphone provided in the present disclosure will be partially outlined in the following description. The inventive aspects of the earphone provided in the present disclosure may be fully explained through the practice or use of the methods, apparatus, and combinations detailed in the embodiments below.

### BRIEF DESCRIPTION OF THE DRAWINGS

To more clearly illustrate the technical solutions of the embodiments of the present disclosure, a brief description of the drawings required for the description of the embodiments is provided below. It is apparent that the drawings described below are merely some embodiments of the present disclosure, and for those of ordinary skill in the art, other drawings may also be obtained based on these drawings without inventive effort.

FIG. 1A shows a schematic structural diagram of an earphone according to some embodiments of the present disclosure;

FIG. 1B shows a cross-sectional view taken along line A-A of the earphone shown in FIG. 1A of the present disclosure;

FIG. 2A shows a schematic diagram of a waterproof acoustic module installed in an accommodation cavity according to some embodiments of the present disclosure;

FIG. 2B shows a schematic diagram of a waterproof acoustic module according to some embodiments of the present disclosure;

FIG. 2C shows a cross-sectional view taken along line B-B of the waterproof acoustic module shown in FIG. 2B of the present disclosure;

FIG. 3 shows a schematic structural diagram of another waterproof acoustic module according to embodiments provided in the present disclosure;

FIG. 4A shows a schematic structural diagram of an acoustic assembly and an accommodation cavity according to some embodiments of the present disclosure;

FIG. 4B shows another cross-sectional view taken along line A-A of the earphone shown in FIG. 1A of the present disclosure;

FIG. 4C shows an enlarged view of section C shown in FIG. 4B provided in the present disclosure;

FIG. 5 shows a schematic structural diagram of a first waterproof acoustic module according to some embodiments of the present disclosure;

FIG. 6 shows a schematic diagram of a first housing sidewall according to some embodiments of the present disclosure;

FIG. 7A shows a line chart of a sensitivity of an acoustic sensor under a scheme A according to some embodiments of the present disclosure; and

FIG. 7B shows a line chart of a sensitivity of an acoustic sensor under a scheme B according to some embodiments of the present disclosure.

### DETAILED DESCRIPTION

The following description provides specific application scenarios and requirements of the present disclosure, aiming to enable those skilled in the art to make and use the contents of the present disclosure. Various partial modifications to the disclosed embodiments will be obvious to those skilled in the art, and the general principles defined herein may be applied to other embodiments and applications without departing from the spirit and scope of the present disclosure. Therefore, the present disclosure is not limited to the embodiments shown but is to be accorded the widest scope consistent with the claims.

As indicated in the present disclosure and in the claims, the singular forms “a,” “an,” and “the” may be intended to include the plural forms as well, unless the context clearly indicates otherwise. In general, the terms “comprise,” “comprises,” and/or “comprising,” “include,” “includes,” and/or “including,” when used in this disclosure, specify the presence of stated features, integers, steps, operations, elements, and/or components, but do not preclude the presence or addition of one or more other features, integers, steps, operations, elements, components, and/or groups thereof.

In the present disclosure, terms such as “upper,” “lower,” “left,” “right,” “front,” “rear,” “top,” “bottom,” “inner,” “outer,” “vertical,” “horizontal,” “transverse,” and “longitudinal” indicate orientations or positional relationships based on those shown in the accompanying drawings. These terms are used primarily to better describe the present disclosure and its embodiments and are not intended to limit the indicated devices, elements, or components to having a specific orientation or being constructed and operated in a specific orientation.

Moreover, in addition to indicating orientation or positional relationships, some of the above terms may also be used to express other meanings. For example, the term “upper” may in some cases be used to indicate a certain attachment or connection relationship. Those of ordinary skill in the art can understand the specific meanings of these terms in the present disclosure based on the context.

Furthermore, terms such as “mount,” “set,” “provided with,” “connect,” and “connected” should be interpreted broadly. For example, a connection may be a fixed connection, a detachable connection, or an integral structure; it may be a mechanical connection or an electrical connection; it may be a direct connection, an indirect connection through an intermediary, or an internal communication between two devices, elements, or components. Those of ordinary skill in the art can understand the specific meanings of the above terms in the present disclosure based on the context.

In the present disclosure, the expression “X comprises/includes at least one of A, B, or C” means that X includes at least A, or X includes at least B, or X includes at least C. In other words, X may include any one of A, B, or C alone, or any combination of A, B, and C, as well as other possible contents/elements. “Any combination of A, B, and C” may be A, B, C, AB, AC, BC, or ABC.

In the present disclosure, unless explicitly stated otherwise, an associative relationship between structures may be a direct relationship or an indirect relationship. For example, when describing “A is connected to B,” unless it is explicitly stated that A is directly connected to B, it should be understood that A may be directly connected to B or indirectly connected to B. Similarly, when describing “A is above B,” unless it is explicitly stated that A is directly above B (A and B are adjacent, and A is above B), it should be understood that A may be directly above B or indirectly above B (other elements exist between A and B, and A is above B). The same applies to other similar expressions.

Considering the following description, these and other features of the present disclosure, the operation and function of related elements of the structure, and the combination of parts and the economy of manufacturing may be significantly improved. All these form part of the present disclosure with reference to the accompanying drawings. However, it should be clearly understood that the drawings are for illustrative and descriptive purposes only and are not intended to limit the scope of the present disclosure. It should also be understood that the drawings are not drawn to scale.

When an earphone 01 is provided with two or more acoustic sensors, a sensitivity difference (i.e., Sgap) between the two or more acoustic sensors assembled in the earphone 01 often exists due to factors such as installation errors, variations in acoustic sensor components, etc. This results in poor sensitivity (also referred to as assembled sensitivity) consistency among different earphones 01 after the acoustic sensors are assembled in the earphones 01, thereby affecting the yield rate of the earphone 01. The assembled sensitivity consistency refers to a difference in Sgap of different earphones 01, and a poor assembled sensitivity consistency indicates that the difference in Sgap among the earphones 01 is relatively large. In such cases, the assembled sensitivity consistency among multiple earphones 01 can be modulated using a preset algorithm. For example, an assembled sensitivity difference among multiple acoustic sensors in an earphone A is SgapA; an assembled sensitivity difference among multiple acoustic sensors in an earphone B is SgapB; and an assembled sensitivity difference among multiple acoustic sensors in an earphone C is SgapC. For the earphones A, B, and C, it is desirable to use the same circuit design or algorithm to adjust the Sgaps among their multiple acoustic sensors. Therefore, the differences between any two of SgapA, SgapB, and SgapC must be maintained within a preset range to ensure good assembled sensitivity consistency. However, algorithmic adjustments typically have certain threshold limitations, making it difficult to simultaneously improve sensitivity consistency across multiple earphones and ensure a high yield rate.

To address this problem, the present disclosure provides an earphone comprising at least one waterproof acoustic module. The waterproof acoustic module is a standalone unit separate from a housing of the earphone. Since the waterproof acoustic module has already undergone liquid (water) resistance treatment, its assembled sensitivity is essentially fixed. By arranging an independent acoustic module 20, the assembled sensitivity difference of the earphone 01 can be flexibly adjusted, thereby improving the assembled sensitivity consistency across different earphones 01. This ensures that the assembled sensitivity differences Sgap between different earphones 01 remain within a preset range, ultimately guaranteeing a high yield rate for the earphone 01.

The following provides a detailed description of the present disclosure through specific embodiments.

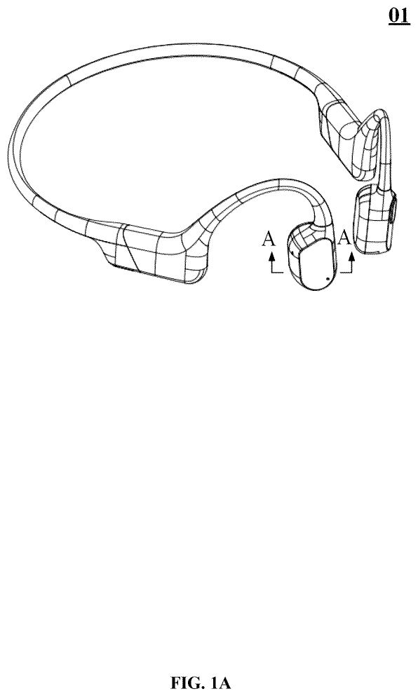

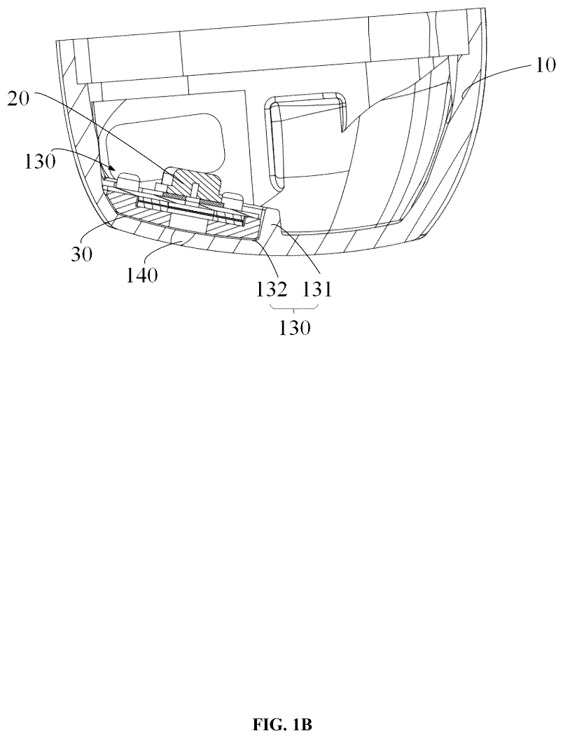

FIG. 1A shows a schematic structural diagram of an earphone according to some embodiments of the present disclosure. FIG. 1B shows a cross-sectional view taken along line A-A of the earphone shown in FIG. 1A of the present disclosure. The earphone shown in FIG. 1A is a wireless earphone. It should be noted that the wireless earphone may be a bone-conduction earphone, an air-conduction earphone, or a bone-and-air-conduction hybrid earphone. Alternatively, the earphone may also be a wired earphone. As shown in FIG. 1B, the earphone 01 may include a housing 10 and at least one waterproof acoustic module 20.

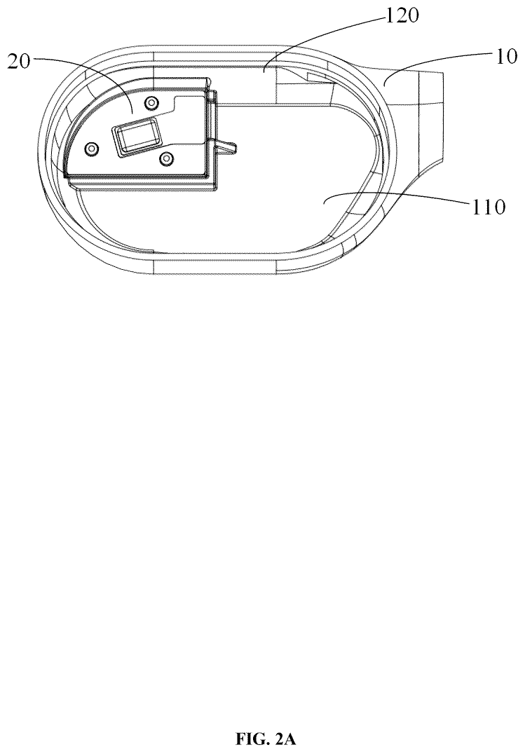

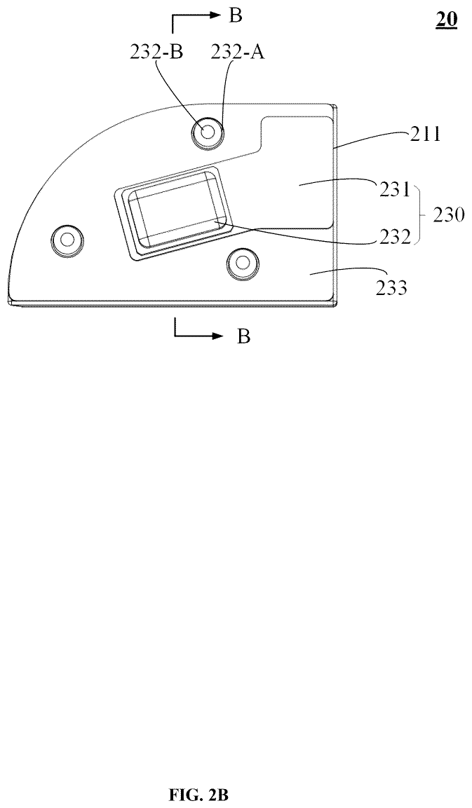

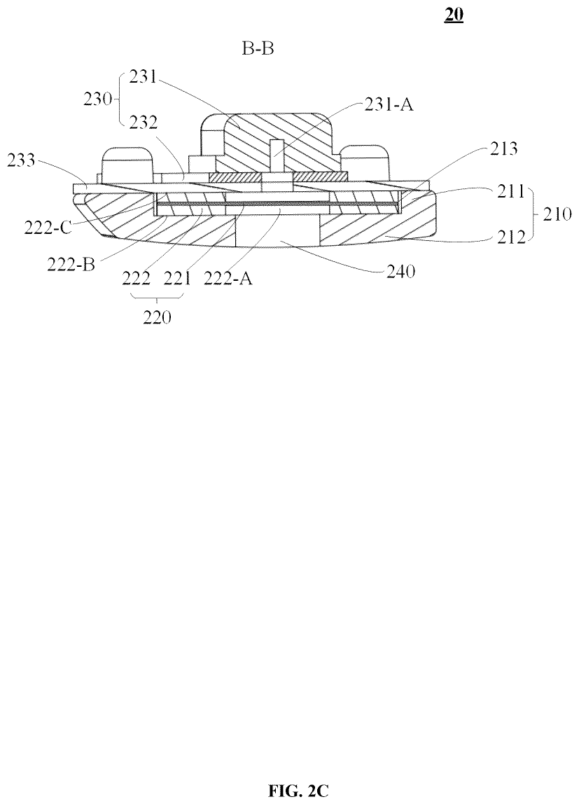

The housing 10 may serve as a mounting component of the earphone 01. Other components (e.g., the waterproof acoustic module 20, etc.) of the earphone 01 may be mounted using the housing 10 as a carrier. The housing 10 may include an inner wall and an outer wall. The outer wall may be a final exterior surface presented to a user, which may be a smooth curved surface. The inner wall may be provided with one or more grooves or one or more protrusions to facilitate assembly. As shown in FIG. 2A, the inner wall of the housing 10 may include a housing bottom wall 110 and a housing side wall 120. The housing bottom wall 110 and the housing side wall 120 collectively enclose an internal space, and other components of the earphone 01 may be housed in the internal space.

The housing 10 may be configured in any shapes, such as a racetrack-shaped (rounded rectangle) or a circular shape. In some embodiments, the housing 10 may consist of two parts that are snapped together after assembling other components, forming the exterior appearance of the earphone 01 as seen by the user. The shape of the housing 10 is not limited and may be designed arbitrarily. For example, the housing 10 of the earphone 01 may be shaped to conform to the contour of a human ear, ensuring that the wireless earphone can be worn securely on the ear of the user. The housing 10 may also be made of any material, such as metal, plastic, polymer materials, etc. The present disclosure imposes no limitations on the shape or the material of the housing 10.

As shown in FIG. 1B, at least one accommodation cavity 130 may be formed on the inner wall of the housing 10. Specifically, the inner wall of the housing 10 may form an accommodation side wall 131 and an accommodation bottom wall 132 of the accommodation cavity 130. For example, the housing bottom wall 110 of the housing 10 may form the accommodation side wall 131 and the accommodation bottom wall 132. Alternatively, the housing bottom wall 110 may form part of the accommodation side wall 131 and the accommodation bottom wall 132, and the housing side wall 120 may form another part of the accommodation side wall 131 and the accommodation bottom wall 132. In some embodiments, the accommodation cavity 130 may also be a space enclosed by other components.

At least one sound transmission hole 140 is formed on the inner wall of the housing 10. The at least one sound transmission hole 140 penetrates through the housing 10 and communicates with the at least one accommodation cavity 130. For example, the accommodation bottom wall 132 of each accommodation cavity 130 may be provided with a sound transmission hole 140. The sound transmission hole 140 may penetrate through the accommodation bottom wall 132, connecting the internal space of the housing 10 with an external space. In some embodiments, for each of the at least one sound transmission hole 140, an aperture of the sound transmission hole 140 on the inner wall of the housing 10 may be smaller than an aperture of the sound transmission hole 140 on the outer wall of the housing 10. The “aperture” refers to the diameter of an opening of the sound transmission hole on the wall surface. In other words, the sound transmission hole 140 may have a flared shape that is wider externally and narrower internally. By designing the sound transmission hole 140 with the flared shape, it is not only convenient for the user to clean foreign matter such as solids or liquids entering the sound transmission hole 140 more conveniently, but also ensures smooth demolding during a machining process of the sound transmission hole 140.

In some embodiments, a central axis of each of the at least one sound transmission hole 140 may be inclined relative to the accommodation bottom wall 132 to prevent water from entering the interior of the housing 10 through the sound transmission hole 140. The central axis of the sound transmission hole 140 may be defined as a line connecting a center of a first opening on the inner wall of the housing 10 with a center of a second opening on the outer wall of the housing 10. An inclination angle of the central axis of the sound transmission hole 140 relative to the accommodation bottom wall 132 may be determined based on product design and machining requirements, as long as it does not adversely affect the acoustic performance of the earphone 01. In some embodiments, the inclination angle may be in a range of [30, 90) degrees. When the inclination angle is within [60, 90) degrees, it ensures a certain degree of inclination and also reduces the machining difficulty of the sound transmission hole 140. When the inclination angle is within [30, 60] degrees, keeping the inclination angle within this range can further enhance the ability to block water from entering the interior of the housing 10 through the sound transmission hole 140. In some application scenarios, such as swimming, by inclining the sound transmission hole 140, the earphone 01 can withstand dynamic water pressure without allowing water to flow directly into the sound transmission hole 140, thereby improving the waterproof capability of the earphone 01 under dynamic water pressure. The shape of the sound transmission hole 140 may be circular, oval, square, rectangular, L-shaped, or any other shape. The present disclosure does not impose limitations on the shape of the sound transmission hole 140.

In some embodiments, the earphone 01 may include at least one accommodation cavity 130 to respectively accommodate multiple components, such as at least one waterproof acoustic module 20. In some embodiments, the accommodation cavity 130 may include a first accommodation cavity and a second accommodation cavity. The first accommodation cavity may include a first sound transmission hole, and the second accommodation cavity may include a second sound transmission hole. The first accommodation cavity may be provided on the housing bottom wall 110, and the second accommodation cavity may be provided on the housing side wall 120, thereby enabling sound transmission holes 140 in different accommodation cavities to receive sound from different directions or transmit sound in different directions. In some embodiments, both the first accommodation cavity and the second accommodation cavity may be provided on the housing bottom wall 110 or the housing side wall 120 to enhance the ability of the sound transmission holes 140 to receive sound from the same direction or transmit sound in the same direction.

The at least one waterproof acoustic module 20 may be disposed in the at least one accommodation cavity 130 and covers the at least one sound transmission hole 140 to prevent liquid from entering the internal space of the housing 10 through the sound transmission hole(s). FIG. 2A shows a schematic diagram of a waterproof acoustic module 20 installed in an accommodation cavity 130 according to some embodiments of the present disclosure. FIG. 2B shows a schematic diagram of a waterproof acoustic module 20 according to some embodiments of the present disclosure. FIG. 2C shows a cross-sectional view taken along line B-B of the waterproof acoustic module 20 shown in FIG. 2B of the present disclosure. The waterproof acoustic module 20 may include a base 210, a waterproof assembly 220, an acoustic assembly 230, and a communication hole 240.

As shown in FIG. 2A, the overall shape of the base 210 may be adapted to an accommodation space of the accommodation cavity 130 to facilitate installation within the accommodation cavity 130. As illustrated in FIG. 2C, the base 210 may include a base side wall 211 and a base bottom wall 212. The base side wall 211 and the base bottom wall 212 form a base accommodation cavity 213 to accommodate other components (e.g., the waterproof assembly 220, the acoustic assembly 230, etc.). The base 210 may be provided with the communication hole 240. The communication hole 240 may penetrate through the base bottom wall 212 and communicate with the base accommodation cavity 213. For example, the communication hole 240 may be formed in the base bottom wall 212. After the base 210 is installed in the accommodation cavity 130, the communication hole 240 and the sound transmission hole 140 on the accommodation cavity 130 may communicate with each other, ensuring that sound can be transmitted into or out of the earphone through the two holes. In some embodiments, the communication hole 240 may be non-coaxial with an opening of the sound transmission hole 140 on the wall surface of the accommodation bottom wall 132 facing the base 210. In some embodiments, the communication hole 240 may be coaxial with the opening of the sound transmission hole 140 on the wall surface of the accommodation bottom wall 132 facing the base 210 to minimize a sound transmission path and provide the earphone 01 with excellent acoustic performance. The communication hole 240 is coaxial with the opening of the sound transmission hole 140 on the wall surface of the accommodation bottom wall 132 facing the base 210 refers to that a central axis of the communication hole 240 coincides with a central axis of the opening of the sound transmission hole 140 on the wall surface of the accommodation bottom wall 132 facing the base 210.

As shown in FIG. 2C, the waterproof assembly 220 may be installed within the base accommodation cavity 213, forming a sealed connection with the base accommodation cavity 213 and covering the communication hole 240, thereby preventing liquids (e.g., water) from entering the base accommodation cavity 213 through the communication hole 240. The acoustic assembly 230 may be arranged on a side of the waterproof assembly 220 away from the base bottom wall 212.

In some embodiments, the waterproof assembly 220 may include a waterproof membrane 221 and one or more buffer members 222. The waterproof membrane 221 allows air to pass through while blocking water. A central hole 222-A may be formed in each buffer member 222. The one or more buffer members 222 may abut against an edge region of the waterproof membrane 221. Specifically, a non-perforated edge region of the buffer member 222 may abut against the edge region of the waterproof membrane 221. In some embodiments, the central hole 222-A may be non-coaxial with an opening of the sound transmission hole 140 on the inner wall of the housing 10. In some embodiments, the central hole 222-A may be coaxial with the opening of the sound transmission hole 140 on the inner wall of the housing 10, to allow the waterproof membrane 221 to uniformly withstand water pressure from water flowing in through the sound transmission hole 140, thereby reducing the risk of damage to the waterproof membrane 221 due to uneven water pressure, and preventing degradation or failure of the waterproof performance of the waterproof assembly 220. The central hole 222-A being coaxial with the opening of the sound transmission hole 140 on the inner wall of the housing 10 may mean that a central axis of the central hole 222-A coincides with a central axis of the opening of the sound transmission hole 140 on the inner wall of the housing 10. The shape of the central hole 222-A may be circular, oval, square, rectangular, or any other shape. The present disclosure does not impose limitations on the shape of the central hole 222-A. In some embodiments, the shape of the central hole 222-A may adapt to the shape of the sound transmission hole 140, and the aperture of the sound transmission hole 140 may be less than or equal to the aperture of the central hole 222-A. This configuration ensures that a relatively large region of the waterproof membrane 221 can withstand water pressure, reducing the likelihood of damage. Here, the “aperture” refers to the diameter of the hole.

In some embodiments, the waterproof assembly 220 may have one or more adhesive surfaces such that, after the waterproof assembly 220 is placed in the base accommodation cavity 213, the one or more adhesive surfaces can be bonded to the base bottom wall 212, thereby achieving sealed connection between the waterproof assembly 220 and the base bottom wall 212 and fixing the waterproof assembly 220 in place. For example, the waterproof assembly 220 may include a first adhesive surface 222-B and a second adhesive surface 222-C. The first adhesive surface 222-B may bond the waterproof assembly 220 to the base accommodation cavity 213 after being subjected to external pressure. The external pressure may come from the weight of the acoustic assembly 230 or pressure applied by a pressure fixture. The second adhesive surface 222-C may seal and bond the waterproof assembly 220 to the acoustic assembly 230 when the waterproof assembly 220 comes into contact with the acoustic assembly 230.

Specifically, the waterproof assembly 220 may include two buffer members 222, positioned on two sides of the waterproof membrane 221. Surfaces of the buffer members 222 facing the base accommodation cavity 213 and the acoustic assembly 230 may be adhesive. By incorporating these adhesive surfaces, the waterproof assembly 220 is securely fixed within the base accommodation cavity 213 through bonding, thereby achieving a waterproof effect while ensuring ease and convenience during the assembly process.

Furthermore, the buffer members 222 may also possess elasticity. The buffer members 222 may evenly distribute high-velocity physical pressure (impact energy) exerted on the waterproof assembly 220, thereby protecting the waterproof membrane 221 from wrinkling due to large impacts during installation of the waterproof assembly 220, which could otherwise affect its waterproof and acoustic performance. In some embodiments, the buffer members 222 may be made of a foam adhesive, an elastic acrylic adhesive, or a foam substrate combined with an elastic acrylic adhesive. In some embodiments, the thickness of a single buffer member 222 is greater than or equal to 0.1 mm. When the buffer members 222 have a certain thickness, they increase the height/thickness of the waterproof assembly 220, allowing the waterproof assembly 220 to fit into the designated assembly space within the housing 10, such as adapting to the depth of the base accommodation cavity 213. Additionally, when the buffer member 222 has a certain thickness, the deformability of the waterproof assembly 220 can be enhanced, thereby accommodating manufacturing tolerances of different base accommodation cavities 213 and facilitating the assembly of the waterproof assembly 220 into the base 210.

The acoustic assembly 230 includes an acoustic sensor 231 and a circuit board 232. The acoustic sensor 231 is disposed on a side of the waterproof assembly 220 away from the base bottom wall 212. The circuit board 232 may be located between the acoustic sensor 231 and the waterproof assembly 220.

The acoustic sensor 231 may include a sound hole 231-A. In some embodiments, the acoustic sensor 231 may comprise at least one microphone. The at least one microphone may capture ambient sound passing through the waterproof assembly 220 via the sound hole 231-A. In some embodiments, the acoustic sensor 231 may comprise at least one speaker. During operation, the at least one speaker emits target sound, which passes through the sound hole 231-A and then through the waterproof assembly 220 to exit the earphone 01. The waterproof assembly 220 covers the communication hole 240 to prevent water from passing through and contacting the acoustic sensor 231.

The circuit board 232 may be mechanically connected to the acoustic sensor 231. Mechanical connections mentioned in the present disclosure may include adhesive bonding, welding, seam locking, riveting, etc. For example, the acoustic sensor 231 may be fixed to the circuit board 232 via welding. As previously mentioned, the acoustic assembly 230 may be adhesively bonded to the waterproof assembly 220 through the second adhesive surface 222-C. Specifically, the circuit board 232 may be bonded to the waterproof assembly 220 via the second adhesive surface 222-C. In some embodiments, additional pressure may be applied to the acoustic assembly 230 to enhance the bond between the circuit board 232 and the second adhesive surface 222-C. For example, pressure may be applied using a pressure fixture to press down on the acoustic assembly 230. Alternatively, weights may be placed on the acoustic assembly 230 to apply pressure.

In some embodiments, at least a portion of the circuit board 232 may be located within the base accommodation cavity 213. In some embodiments, the circuit board 232 may be located outside the base accommodation cavity 213. For example, the circuit board 232 may be placed outside the base accommodation cavity 213 and abut against a top surface of the base side wall 211.

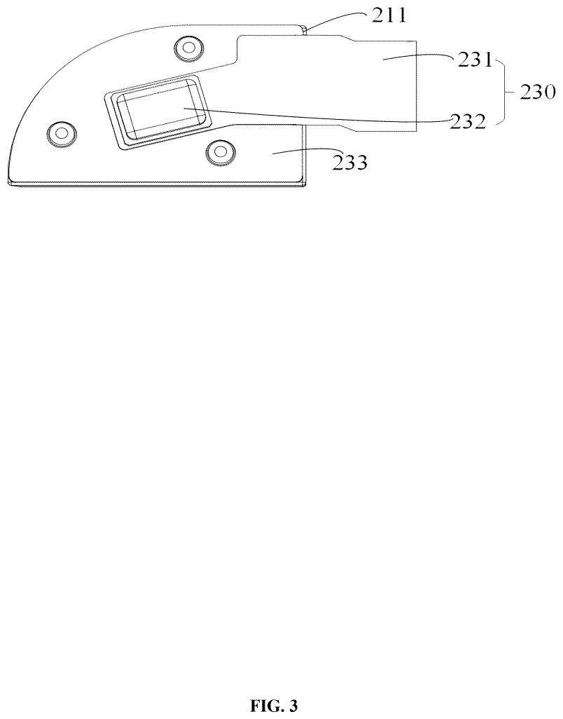

In some embodiments, the circuit board 232 may be flush with an edge of the base 210. For example, as shown in FIG. 2A, an edge of the circuit board 232 is flush with an edge of the base side wall 211. In some embodiments, a coverage range of the circuit board 232 may extend beyond the base 210. FIG. 3 illustrates a schematic structural diagram of another waterproof acoustic module 20 according to some embodiments of the present disclosure. As shown in FIG. 3, a right side of the circuit board 232 extends beyond the edge of the base side wall 211. The portion of the circuit board 232 that extends beyond the edge of the base side wall 211 may past over the base side wall 211 and then bend to contact the housing bottom wall 110 or the housing side wall 120. Designing the circuit board 232 to extend beyond the base 210 facilitates the connection of multiple waterproof acoustic modules 20 when they are used together.

In some embodiments, the circuit board 232 may be provided with a plurality of positioning holes 232-A, and the top surface of the base side wall 211 may be provided with a plurality of positioning protrusions 232-B corresponding to the plurality of positioning holes 232-A. Providing the positioning holes 232-A and the positioning protrusions 232-B facilitates the alignment of the sound hole 231-A with the central hole 222-A of the buffer member 222, ensuring the shortest sound transmission path and maintaining excellent acoustic performance for the earphone 01. The count of the positioning protrusions 232-B and the count of the positioning holes 232-A may be three, as shown in FIG. 2B. The present disclosure does not impose limitations on the count of the positioning protrusions and the positioning holes. In some embodiments, the plurality of positioning protrusions 232-B may be approximately uniformly arranged around the waterproof assembly 220 or the acoustic sensor 231 to facilitate positioning. For example, as shown in FIG. 2B, three positioning protrusions 232-B are connected to form a triangle, and the three positioning protrusions 232-B are approximately uniformly arranged around the acoustic sensor 231.

In some embodiments, the positioning protrusions 232-B may be cylindrical, as shown in FIG. 2B. In some embodiments, the positioning protrusions 232-B may also take the form of a frustum with a narrower top and a wider bottom, thereby preventing interference with the positioning holes 232-A during installation. In some embodiments, each of the positioning protrusions 232-B includes a shank and an enlarged head. The shank of each of the positioning protrusions 232-B is inserted into the positioning hole 232-A corresponding to the positioning protrusion 232-B.

In some embodiments, the circuit board 232 may be a Printed Circuit Board (PCB). The PCB is resistant to bending and possess a certain rigidity, making them well-suited for supporting the acoustic sensor 231.

In some embodiments, the circuit board 232 may be a Flexible Printed Circuit (FPC). As mentioned earlier, to enhance the local thickness or rigidity of the FPC while ensuring its flatness, the FPC may undergo local or overall reinforcement. In some embodiments, the acoustic assembly 230 may also include a reinforcing plate 233 made of a steel plate or a Polyimide (PI) material to strengthen the FPC. The PI material is an engineering plastic with excellent mechanical properties, characterized by its light weight, thin profile, and good flexibility. The reinforcing plate 233, used to enhance the strength of the circuit board 232, may be positioned between the circuit board 232 and the waterproof assembly 220, as shown in FIG. 2C. The reinforcing plate 233 may abut against the top surface of the base side wall 211. In some embodiments, a thickness of the reinforcing plate 233 may range from 0.05 mm to 0.5 mm, thereby ensuring improved strength of the circuit board 232 and minimizing space occupancy.

Therefore, the plurality of positioning holes 232-A may be provided on the reinforcing plate 233. As shown in FIG. 2B, the reinforcing plate 233 is provided with three positioning holes 232-A that are arranged in a triangular pattern and approximately uniformly distributed around the acoustic sensor 231.

In some embodiments, the positioning protrusions 232-B are made of a thermoplastic material. Ends of the positioning protrusions 232-B are heated and pressed to form enlarged heads. Using this heat-melting and pressing technique, the positioning protrusions 232-B form a rivet-like structure. This approach is not only simple and efficient but also seals gaps between the positioning protrusions 232-B and the positioning holes 232-A with the thermoplastic material, thereby eliminating the need for additional sealing of the gaps between the positioning protrusions 232-B and the positioning holes 232-A, simplifying procedures, improving efficiency, and reducing costs.

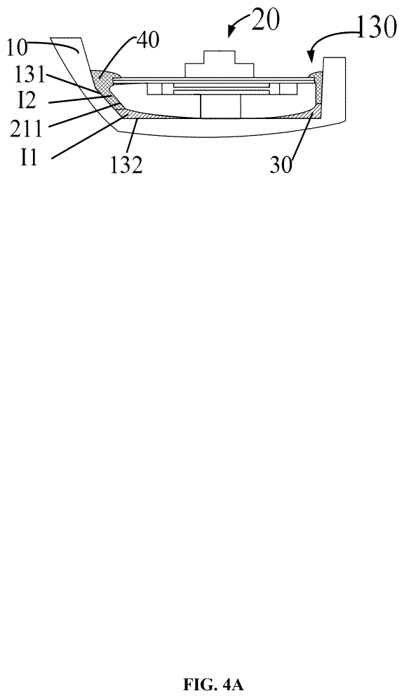

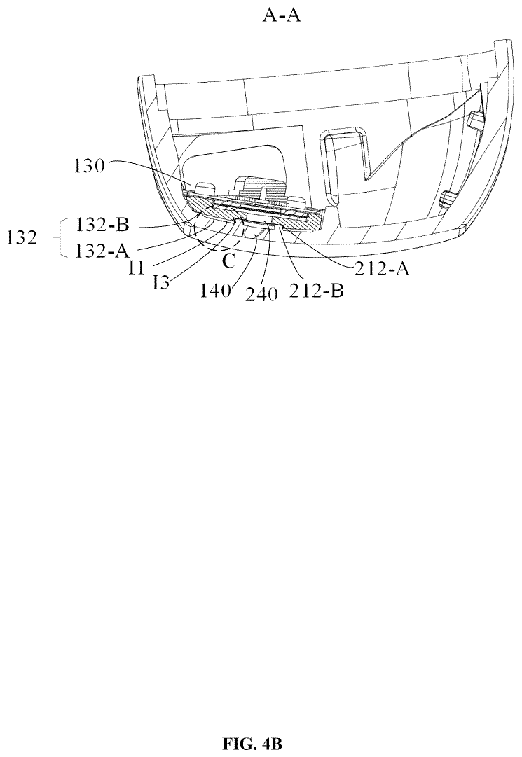

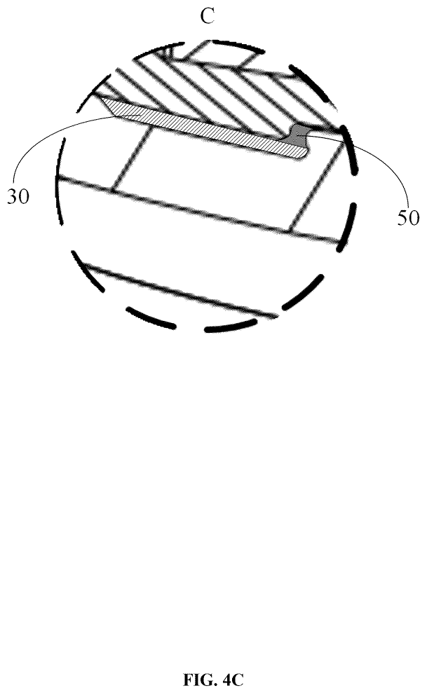

FIG. 4A shows a schematic structural diagram of an acoustic assembly 20 and an accommodation cavity 130 according to some embodiments of the present disclosure. FIG. 4B shows another cross-sectional view taken along line A-A of the earphone 01 shown in FIG. 1 of the present disclosure. FIG. 4C shows an enlarged view of section C shown in FIG. 4B provided in the present disclosure.

To reduce the assembly difficulty between the waterproof acoustic module 20 and the accommodation cavity 130, a dimension of the waterproof acoustic module 20 may be slightly smaller than a dimension of the accommodation cavity 130. Consequently, a gap may exist between the waterproof acoustic module 20 and the accommodation side wall 131. In some embodiments, a second gap I2 may be formed between the base side wall 211 and the accommodation side wall 131, as shown in FIG. 4A. A second sealing member 40, which seals the second gap I2, may be obtained by providing a fluid sealing material into the second gap and subsequently curing the fluid sealing material. For example, the second sealing member 40 may be silicone, hot melt adhesive, UV-curable adhesive, etc. These sealing adhesives offer advantages such as strong adhesion, low environmental impact, and fast curing.

In some embodiments, after the waterproof acoustic module 20 is installed in the accommodation cavity 130, the base bottom wall 212 of the base 210 abuts against the accommodation bottom wall 132, forming a first gap I1, as shown in FIG. 4A. The first gap I1 may be sealed using a first sealing member 30.

In some embodiments, the first sealing member 30 may be a pre-formed gasket. The first sealing member 30 is pre-adhered to the accommodation bottom wall 132, and the waterproof acoustic module 20 is then placed on the first sealing member 30, so that the waterproof acoustic module 20 is secured within the accommodation cavity 130. In some embodiments, the gasket may be double-sided tape, foam tape, or a foam substrate with double-sided tape.

As mentioned earlier, the accommodation side wall 131 and the accommodation bottom wall 132 of the accommodation cavity 130 may be formed in the interior of the housing 10. In some embodiments, the accommodation bottom wall 132 may include a first step. As shown in FIG. 4B, the first step divides the accommodation bottom wall 132 into a first bottom wall portion 132-A and a second bottom wall portion 132-B. The communication hole 240 penetrates through the first bottom wall portion 132-A and communicates with the accommodation cavity 130. The base 210 may abut against the second bottom wall portion 132-B. The first gap I1 described above may be formed between the base 210 and the first bottom wall portion 132-A. The first sealing member 30 may be provided within the first gap I1 and seal the first gap I1. The first sealing member 30 may be formed by providing the fluid sealing material into the first gap I1 and subsequently curing the fluid sealing material.

Since the fluid sealing material may enter the sound transmission hole 140 during flow, the fluid sealing material partially or completely fills the sound transmission hole 140, thereby affecting sound intake. Moreover, when the sound transmission hole 140 is inclined, it becomes even more difficult to remove the fluid sealing material that has flowed into the sound transmission hole 140. In some embodiments, by providing limiting portions on the base bottom wall 212 and the accommodation bottom wall 132, the flow of the fluid sealing material into the sound transmission hole 140 can be prevented.

In some embodiments, a first limiting portion 212-A is provided on the base bottom wall 212 circumferentially around the communication hole 240, and a second limiting portion is provided on the accommodation bottom wall 132 circumferentially around the communication hole 240. For example, as shown in FIG. 4B, the base bottom wall 212 is provided with an annular first limiting portion 212-A around the opening of the communication hole 240. The accommodation bottom wall 132 is provided with an annular second limiting portion 212-B around the opening of the sound transmission hole 140. The first limiting portion 212-A is located on a side of the base bottom wall 212 facing the accommodation cavity 130. The first limiting portion 212-A and the second limiting portion 212-B engage with and abut against each other, thereby preventing the fluid sealing material from flowing into the sound transmission hole 140. By providing the first limiting portion 212-A and the second limiting portion 212-B, all potential pathways for the fluid sealing material to enter the sound transmission hole 140 are blocked.

In some embodiments, as shown in FIG. 4B, the first limiting portion 212-A comprises a groove provided on the base bottom wall 212 and arranged circumferentially around the communication hole 240, and the second limiting portion 212-B comprises a second step provided on the accommodation bottom wall 132 and arranged circumferentially around the sound transmission hole 140. The second step or similar protrusion acts as a barrier to prevent the fluid sealing material from flowing into the sound transmission hole 140. By providing a corresponding groove, the base bottom wall 212 can better engage with and abut against the second limiting portion 212-B, more effectively blocking the flow of the fluid sealing material into the sound transmission hole 140. By providing the groove and the second step, the fluid sealing material can be prevented from entering the sound transmission hole 140, and this configuration also serves a positioning function when the waterproof acoustic module 20 is placed into the accommodation cavity 130.

In some embodiments, considering manufacturing tolerances and to reduce the assembly difficulty between the waterproof acoustic module 20 and the accommodation cavity 130, a width of an opening of the groove may be slightly larger than a width of the second step. Therefore, a third gap may be formed between the first limiting portion 212-A and the second limiting portion 212-B. Referring to FIG. 4C, the third gap may be sealed by a third sealing member 50. The third sealing member 50 may be formed by providing the fluid sealing material into the third gap and subsequently curing the fluid sealing material. In some embodiments, the third sealing member 50 may be a UV-curable adhesive, silicone, a hot melt adhesive, etc. In some embodiments, after the fluid sealing material of the first sealing member 30 flows into the first gap, if an excess amount of the fluid sealing material enters the third gap, the third gap may be sealed by the third sealing member 50. The third gap not only ensures that the fluid sealing material does not enter the sound transmission hole 140 but also extends the containment path for the fluid sealing material, allowing a larger amount of the fluid sealing material to be placed between the waterproof acoustic module 20 and the accommodation cavity 130, thereby enhancing the robustness of the connection between the waterproof acoustic module 20 and the accommodation cavity 130.

As mentioned earlier, the earphone 01 may include at least one waterproof acoustic module 20. In some embodiments, the earphone 01 may include only a single acoustic module 20. In some embodiments, the earphone 01 may include a plurality of acoustic modules 20, thereby incorporating a plurality of acoustic sensors 231 to enable additional functionalities. Two circuit boards 232 of any two waterproof acoustic modules 20 may be connected via a flexible printed circuit (FPC) to establish a connection the two waterproof acoustic modules 20. Alternatively, two circuit boards 232 of any two waterproof acoustic modules 20 may be directly connected to establish the connection between the two waterproof acoustic modules 20.

In some embodiments, the earphone 01 may include two acoustic modules 20, thus incorporating two acoustic sensors 231. For example, when the acoustic sensors 231 are microphones, configuring two microphones within the earphone can achieve noise cancellation effects. One microphone may serve as a standard microphone for user calls, capturing voice signals. The other microphone may be designed for noise collection, facilitating the capture of ambient environmental noise.

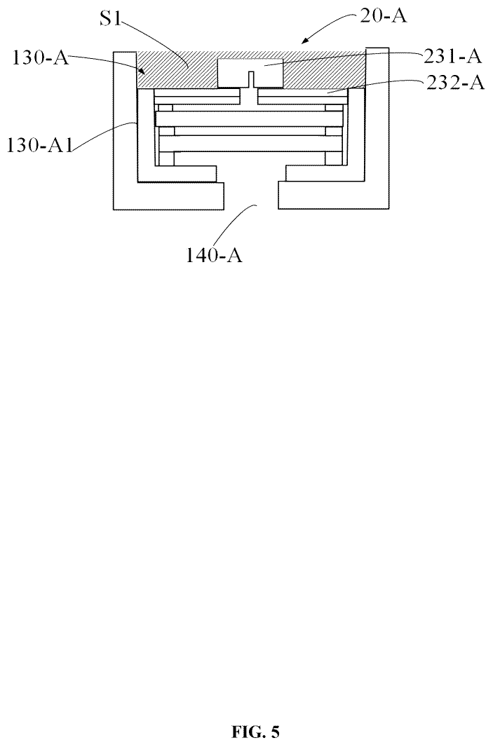

As previously described, the housing 10 may include two accommodation cavities 130. The two accommodation cavities 130 may respectively accommodate two waterproof acoustic modules 20 (i.e., a first waterproof acoustic module 20-A and a second waterproof acoustic module 20-B). The second waterproof acoustic module 20-B is not shown in FIG. 5). FIG. 5 illustrates a schematic structural diagram of the first waterproof acoustic module 20-A according to some embodiments of the present disclosure.

The first waterproof acoustic module 20-A is disposed in a first accommodation cavity 130-A and covers the first sound transmission hole 140-A. The first waterproof acoustic module 20-A may include a first acoustic sensor 231-A and a first circuit board 232-A. The inner wall of the housing 10 may form a first accommodation side wall 130-A1 of the first accommodation cavity 130-A. The first accommodation side wall 130-A1 is higher than an upper surface of the first circuit board 232-A, thereby forming a first accommodation space S1 for accommodating a sealing material. The sealing material may be the aforementioned sealing adhesive.

The second waterproof acoustic module is disposed in the second accommodation cavity and covers the second sound transmission hole. The second waterproof acoustic module may include a second acoustic sensor and a second circuit board. The inner wall of the housing 10 may form a second accommodation side wall of the second accommodation cavity. The second accommodation side wall may be higher than an upper surface of the second circuit board, thereby forming a second accommodation space for accommodating the sealing material. The structure of the second accommodation space may be similar to the structure of the first accommodation space described above.

The first circuit board and the second circuit board may be directly connected or connected via an additional flexible printed circuit (FPC), thereby establishing a connection between the first waterproof acoustic module and the second waterproof acoustic module.

In some embodiments, both the first circuit board 232-A and the second circuit board may be the aforementioned type of circuit board 232 whose right side extends beyond the edge of the base side wall 211. Accordingly, the portions of the first circuit board 232-A and the second circuit board that extend beyond their respective base side walls 211 may extend past their respective base side walls 211 and, after being bent, come into contact with the housing bottom wall 110 or the housing side wall 120. In some embodiments, the first circuit board 232-A and the second circuit board may contact each other directly, and the contacting portions may be welded together. In some embodiments, when the first circuit board 232-A and the second circuit board are PCBs, the two circuit boards may also be electrically connected via a board-to-board connector (a BTB connector). In some embodiments, if the portions of the first circuit board 232-A and the second circuit board extending beyond the base side wall 211 cannot contact each other directly, the two circuit boards 232 may be connected using a connecting circuit board. The connecting circuit board may be an FPC or a PCB.

As mentioned earlier, the first circuit board 232-A may be an FPC, and the right side of the first circuit board 232-A may extend beyond the edge of the base side wall on which the first circuit board 232-A is located. Therefore, when the first accommodation side wall 130-A1 is higher than the upper surface of the first circuit board 232-A, the first circuit board 232-A needs to be bent inside the first accommodation cavity 130-A, extend out and pass over the first accommodation cavity 130-A, and then bent again towards the housing bottom wall 110 or the housing side wall 120 to connect with the connecting circuit board or the second circuit board.

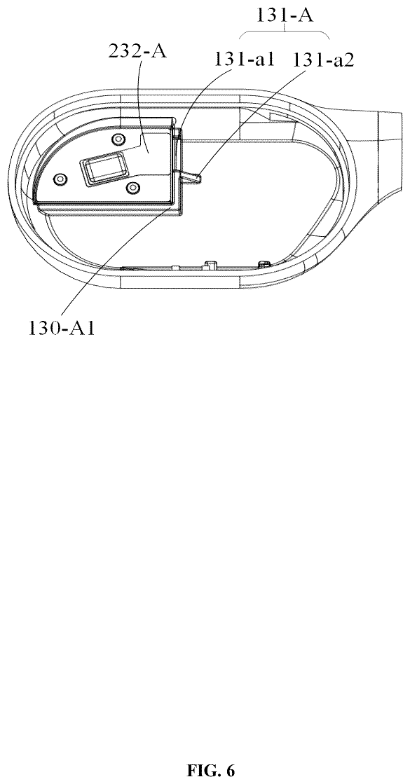

FIG. 6 illustrates a schematic diagram of the first accommodation side wall 130-A1 according to some embodiments of the present disclosure. The portion of the first circuit board 232-A extending beyond the edge of the first accommodation side wall 130-A1 is not shown in FIG. 6. To reduce a bending degree required for the first circuit board 232-A to pass over the first accommodation cavity 130-A and prevent damage due to excessive bending at the first accommodation side wall 130-A1, as shown in FIG. 6, a target segment 131-A may be provided on the first accommodation side wall 130-A1. The first circuit board 232 may pass over the first accommodation side wall 130-A1 via the target segment 131-A.

The target segment 131-A may feature a smoother design compared to other portions of the first accommodation side wall 130-A1, thereby reducing the bending degree of the first circuit board 232-A at the first accommodation side wall 130-A1 and consequently extending its service life. For example, edges of the other portions of the first accommodation side wall 130-A1 may have sharp right angles, the smoother design of the target segment 131-A may be that an edge of the target segment 131-A is a rounded corner. As another example, when the edges of the other portions of the first accommodation side wall 130-A1 are rounded corners having a relatively small curvature radius, the smoother design of the target segment 131-A may be that the edge of the target segment 131-A is a rounded corner having a relatively larger curvature radius. As yet another example, when height differences between the other portions of the first accommodation side wall 130-A1 and the inner wall of the housing 10 are relatively large, the smoother design of the target segment 131-A may be that a height difference between the target segment 131-A and the inner wall of the housing 10 is relatively small and a sloped support is provided between the target segment 131-A and the inner wall of the housing 10. As shown in FIG. 6, the target segment 131-A may comprise a guiding opening 131-a1 formed on the first accommodation side wall 130-A1 and an inclined guiding surface 131-a2. The upper surface of the first circuit board 232-A may be flush with an upper surface of the guiding opening 131-a1, allowing the first circuit board 232-A to pass over the first accommodation side wall 130-A1 without bending. The guiding opening 131-a1 may connect to the inner wall of the housing 10 via the inclined guiding surface 131-a2. Since there is a height difference between the guiding opening 131-a1 and the inner wall of the housing 10, the guiding surface 131-a2 provides support to the circuit board 232, thereby preventing the circuit board 232 from being suspended in air and reducing the risk of damage.

In some embodiments, the bending degree of the first circuit board 232-A at the first accommodation side wall 130-A1 may be measured by a bending angle of the first circuit board 232-A. The smaller bending angle is, the lower the bending degree is. For example, the bending degree when the bending angle is an acute angle is lower than the bending degree when the bending angle is a right angle. If the guiding surface 131-a2 is not provided, the first circuit board 232-A may need to bend at a right angle along the first accommodation side wall 130-A1. As shown in FIG. 6, by providing the inclined guiding surface 131-a2, the first circuit board 232-A can bend downward without forming a sharp bending angle. The support from the guiding surface 131-a2 ensures that the bending angle of the first circuit board 232-A is acute and very small. In some embodiments, compared to a right-angle design of other segments, the target segment 131-A may adopt a rounded corner design, enabling the first circuit board 232-A to bend along the rounded corner when passing over the first accommodation side wall 130-A1, avoiding abrupt bending and thus minimizing damage to the first circuit board 232-A.

In some embodiments, the second accommodation cavity (primarily the second accommodation side wall) accommodating the second waterproof acoustic module may have the same design as the first accommodation cavity, and thus will not be elaborated here. By providing the target segment on the second accommodation side wall, the second circuit board can avoid sharp bending angles during bending, thereby reducing the risk of damage to the second circuit board.

As mentioned earlier, the waterproof acoustic module 20 is designed as a standardized component independent of the housing 10. Since the acoustic module 20 has undergone liquid (water) resistance treatment, its overall sensitivity is essentially fixed. By incorporating a separate acoustic module 20, the sensitivity difference of the earphone 01 can be flexibly adjusted, improving sensitivity consistency across different earphones 01, which ensures that the difference in sensitivity differences (Sgap) between different earphones 01 remains within a predefined range, thereby guaranteeing a high yield rate for the earphones 01. Therefore, when the earphone 01 includes two acoustic sensors, at least one of the two acoustic sensors is from a waterproof acoustic module 20. In some embodiments, two acoustic waterproof modules 20 are installed within the earphone 01, making it easier to control the assembled sensitivity of the acoustic sensors and ensuring assembled sensitivity consistency across different earphones 01.

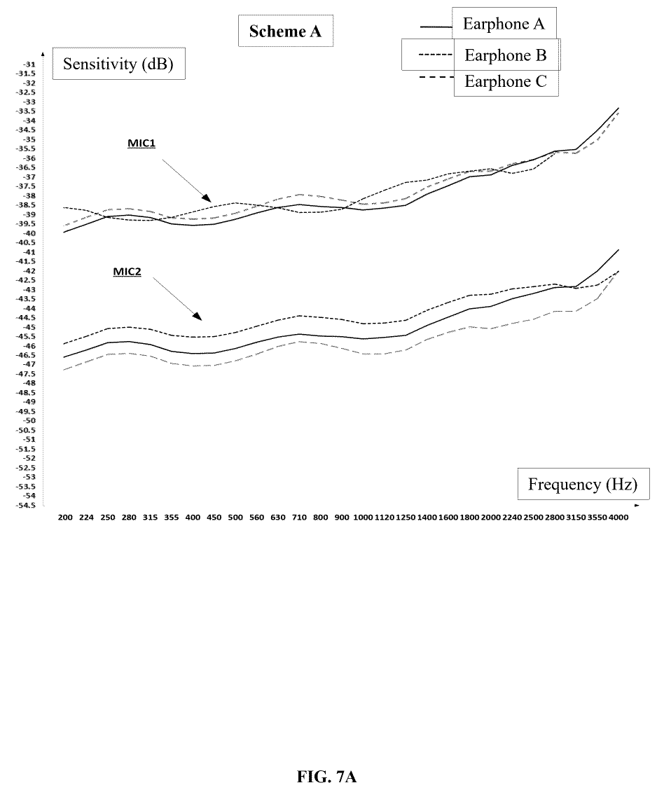

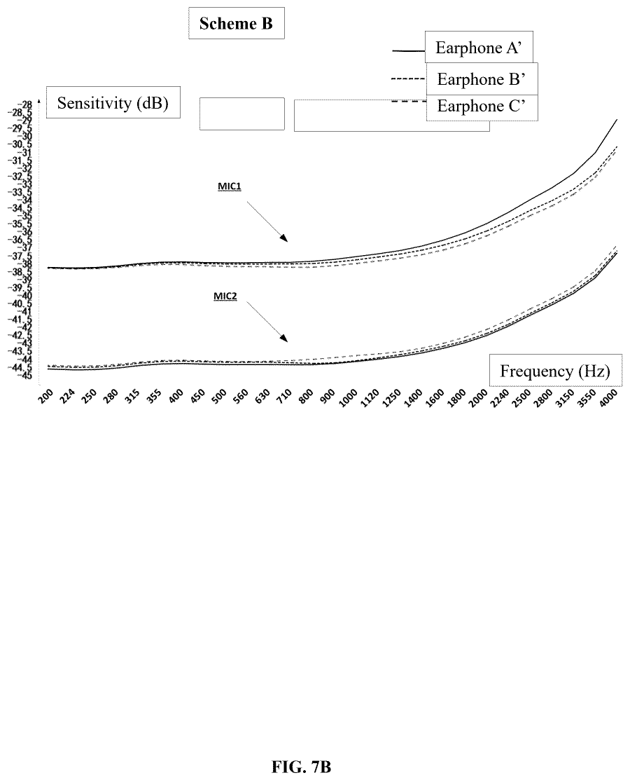

FIG. 7A shows a line chart of a sensitivity of an acoustic sensor under a scheme A according to some embodiments of the present disclosure.

FIG. 7B shows a line chart of a sensitivity of an acoustic sensor under a scheme B according to some embodiments of the present disclosure. The following description uses an example where the earphone 01 is provided with two acoustic sensors, both of which are microphones (MIC1 and MIC2).

The scheme A represents a scenario where the earphone 01 is not provided with waterproof acoustic modules 20. FIG. 7A illustrates sensitivity values of MIC1 and MIC2 in a frequency range of 200 Hz to 4 kHz for three earphones A, B, and C among a plurality of earphones. The sensitivity values for the microphones of the same earphone 01 are represented by a same line type. A sensitivity difference between the two microphones is denoted as Sgap. An average sensitivity difference between the two microphones of the earphone A is denoted as SgapA; an average sensitivity difference between the two microphones of the earphone B is denoted as SgapB; and an average sensitivity difference between the two microphones of the earphone C is denoted as SgapC. A difference SgapA-B between SgapA and SgapB, is approximately 1.07 dB; a difference SgapA-C between SgapA and SgapC, is approximately 1.9 dB; and a difference SgapB-C between SgapB and SgapC, is approximately 0.83 dB. In other words, if it is desired to adjust sensitivity consistency among the earphones, an adjustment threshold of at least 1.9 dB is required.

The scheme B represents a scenario where one microphone in the earphone 01 is from a waterproof acoustic module 20, and the other microphone is not from waterproof acoustic modules 20. FIG. 7B illustrates sensitivity values of MIC1 and MIC2 in a frequency range of 200 Hz to 4 kHz for three earphones A′, B′, and C′ among a plurality of earphones. The sensitivity values of the microphones of the same earphone 01 are represented by a same line type. A sensitivity difference between the two microphones is denoted as Sgap′. An average sensitivity difference between the two microphones of the earphone A′ is denotes as SgapA′; an average sensitivity difference between the two microphones of the earphone B′ is denoted as SgapB′; and an average sensitivity difference between the two microphones of the earphone C′ is denoted as SgapC′. A difference SgapA′-B′ between SgapA′ and SgapB′, is approximately 0.47 dB; a difference SgapA′-C′ between SgapA′ and SgapC′, is approximately 0.85 dB; and a difference SgapB′-C′ between SgapB′ and SgapC′, is approximately 0.38 dB. In other words, if it is desired to adjust sensitivity consistency among the earphones, an adjustment threshold of only 0.85 dB is required.

From the above data, it can be seen that, a maximum difference among the Sgap′ values when the earphone 01 is provided with at least one waterproof acoustic module 20 (e.g., the scheme B) is much smaller than a maximum difference among the Sgap values when the earphone 01 is not provided with waterproof acoustic modules 20 (e.g., the scheme A). Through detection and statistical analysis of microphone sensitivity performed on nearly one hundred earphones 01 employing the scheme A and nearly one hundred earphones 01 employing the scheme B, it is found that an average range of differences in Sgap for the earphones of the scheme A is about 0.83 dB to 2.1 dB, whereas an average range of differences in Sgap′ for the earphones of the scheme B is about 0.3 dB to 0.84 dB. Therefore, it can be concluded that the earphones 01 using the waterproof acoustic module 20 exhibit higher consistency and a higher yield rate.

Thus, it is evident that when two microphones of an earphone 01 are respectively provided by two waterproof acoustic modules 20, i.e., when two waterproof acoustic modules 20 are respectively installed inside the housing 10, the above-described effects can likewise be achieved. In particular, when two waterproof acoustic modules 20 are respectively installed in the earphone 01, the sensitivity of each waterproof acoustic module 20 can be separately measured. When a sensitivity difference of an earphone 01 is excessively large compared with sensitivity differences of other earphones 01, any one of the two waterproof acoustic modules 20 of the earphone 01 may be replaced to adjust the sensitivity difference between the two waterproof acoustic modules 20, and a suitable waterproof acoustic module 20 may then be assembled into the housing 10. Therefore, by standardizing the waterproof acoustic module 20 as a standardized component, it not only enables mass production of waterproof acoustic modules 20 but also ensures that the differences in sensitivity differences between different earphones 01 remains within a predefined range, thereby guaranteeing a high yield rate for the same batch of earphones 01.

The foregoing describes specific embodiments of the present disclosure. Other embodiments fall within the scope of the appended claims. In some cases, the operations or steps recited in the claims may be performed in an order different from that in the embodiments and still achieve the desired results. Additionally, the processes depicted in the accompanying drawings do not necessarily require a specific or sequential order to achieve the desired results. In some embodiments, multitasking and parallel processing are also possible and may be advantageous.

In summary, after reviewing this detailed disclosure, those skilled in the art may understand that the foregoing detailed description is presented by way of example only and is not intended to be limiting. Although not explicitly stated herein, it should be understood that the present disclosure encompasses various reasonable changes, improvements, and modifications to the embodiments. Such changes, improvements, and modifications are intended to be proposed by the present disclosure and fall within the spirit and scope of the exemplary embodiments herein.

Furthermore, certain terms in the present disclosure have been used to describe its embodiments. For example, “an embodiment,” “the embodiment,” and/or “some embodiments” mean that a specific feature, structure, or characteristic described in connection with the embodiment may be included in at least one embodiment of the present disclosure. Therefore, it should be understood that two or more references to “an embodiment,” “one embodiment,” or “an alternative embodiment” in various parts of the present disclosure do not necessarily all refer to the same embodiment. Additionally, specific features, structures, or characteristics may be combined appropriately in one or more embodiments of the present disclosure.

It should be understood that in the foregoing description of the embodiments of the present disclosure, various features have been combined into a single embodiment, drawing, or description for the purpose of simplifying the present disclosure and aiding in the understanding of individual features. However, this is not to imply that the combination of these features is mandatory. Those skilled in the art, upon reading the present disclosure, may extract a subset of features to interpret as separate embodiments. In other words, the embodiments in the present disclosure may also be understood as integrations of multiple sub-embodiments. Each sub-embodiment remains valid even when it contains fewer than all the features of a single aforementioned disclosed embodiment.

Each patent, patent application, publication of patent applications, and other materials cited herein, such as articles, books, specifications, publications, documents, items, etc., may be incorporated by reference for all purposes. The entire content of these materials is incorporated herein, except for any prosecution history associated therewith that may be inconsistent or conflicting with this document, or any prosecution history that may have a limiting effect on the broadest scope of the claims. Any inconsistencies or conflicts between the description, definition, and/or use of terms in any incorporated material and the terms, description, definition, and/or use in the present disclosure shall be resolved in favor of the terms as used in the present disclosure.

Finally, it should be understood that the embodiments of the present disclosure disclosed herein are illustrative of the principles of the embodiments of the present disclosure. Other modified embodiments also fall within the scope of the present disclosure. Accordingly, the embodiments disclosed in the present disclosure are by way of example and not limitation. Those skilled in the art may adopt alternative configurations based on the embodiments herein to implement the present disclosure described in the present disclosure. Therefore, the embodiments of the present disclosure are not limited to those precisely described in the present disclosure.

What is claimed is:

1. An earphone, comprising:
a housing, wherein at least one accommodation cavity and at least one sound transmission hole are formed on an inner wall of the housing, the at least one sound transmission hole penetrates through the housing and communicates with the at least one accommodation cavity;
at least one waterproof acoustic module, wherein each of the at least one waterproof acoustic module comprises a communication hole and a waterproof assembly, and the waterproof assembly is configured to prevent a liquid from entering an interior of the waterproof acoustic module through the communication hole, and
two acoustic sensors, at least one of the two acoustic sensors being located the at least one waterproof acoustic module, wherein
the at least one waterproof acoustic module is disposed in the at least one accommodation cavity and covers the at least one sound transmission hole to prevent the liquid from entering an internal space of the housing through the at least one sound transmission hole,
the at least one waterproof acoustic module is a standalone unit separate from the housing, and
the at least one waterproof acoustic module is mounted using the housing as a carrier.

2. The earphone of claim 1, wherein the at least one waterproof acoustic module comprises a first waterproof acoustic module and a second waterproof acoustic module, the at least one accommodation cavity comprises a first accommodation cavity and a second accommodation cavity, and the at least one sound transmission hole comprises a first sound transmission hole and a second sound transmission hole,
the first waterproof acoustic module is disposed in the first accommodation cavity and covers the first sound transmission hole, and
the second waterproof acoustic module is disposed in the second accommodation cavity and covers the second sound transmission hole.

3. The earphone of claim 2, wherein the inner wall of the housing comprises a housing bottom wall and a housing side wall, the first accommodation cavity and the second accommodation cavity are provided on the housing bottom wall or the first accommodation cavity and the second accommodation cavity are provided on the housing side wall.

4. The earphone of claim 2, wherein the inner wall of the housing comprises a housing bottom wall and a housing side wall,
the first accommodation cavity is provided on the housing bottom wall,
the second accommodation cavity is provided on the housing side wall, and
the first waterproof acoustic module and the second waterproof acoustic module are connected by a flexible circuit board.

5. The earphone of claim 2, wherein the first waterproof acoustic module comprises a first acoustic sensor, the second waterproof acoustic module comprises a second acoustic sensor, the first acoustic sensor is a microphone or a speaker, and the second acoustic sensor is a microphone or a speaker.

6. The earphone of claim 2, wherein the first waterproof acoustic module comprises a first circuit board and the second waterproof acoustic module comprises a second circuit board,
the inner wall of the housing forms a first accommodation side wall of the first accommodation cavity and a second accommodation side wall of the second accommodation cavity,
the first accommodation side wall is higher than an upper surface of the first circuit board, thereby forming a first accommodation space for accommodating a sealing material, and/or,
the second accommodation side wall is higher than an upper surface of the second circuit board, thereby forming a second accommodation space for accommodating a sealing material.

7. The earphone of claim 6, wherein the first circuit board and the second circuit board are connected by a flexible circuit board.

8. The earphone of claim 18, wherein each of the at least one accommodation cavity corresponds to one waterproof acoustic module and comprises an accommodation side wall and an accommodation bottom wall, and each of the at least one sound transmission hole penetrates through the corresponding accommodation bottom wall to connect the internal space of the housing with an external space, and
each of the at least one waterproof acoustic module comprises:
a base comprising a base side wall, a base bottom wall, and the communication hole, wherein the base side wall and the base bottom wall form a base accommodation cavity, the communication hole penetrates through the base bottom wall and communicates with the base accommodation cavity, and the base is in sealed connection with the corresponding accommodation cavity,
the waterproof assembly, disposed in the base accommodation cavity and covering the communication hole to prevent the liquid from entering the base accommodation cavity through the communication hole,
an acoustic assembly comprising an acoustic sensor, wherein the acoustic sensor is disposed on a side of the waterproof assembly away from the base bottom wall, and
a circuit board, located between the acoustic sensor and the waterproof assembly and mechanically connected to the acoustic sensor.

9. The earphone of claim 8, further comprising a first sealing member and a second sealing member, wherein
the base bottom wall abuts against the accommodation bottom wall to form a first gap, and the base side wall and the accommodation side wall form a second gap, and
the first sealing member seals the first gap, and the second sealing member seals the second gap.

10. The earphone of claim 9, wherein the first sealing member is formed by providing a fluid sealing material into the first gap and curing the fluid sealing material, and/or,
the second sealing member is formed by providing the fluid sealing material into the second gap and curing the fluid sealing material.

11. The earphone of claim 9, wherein the first sealing member is a pre-formed sealing gasket.

12. The earphone according to claim 9, wherein
a first limiting portion is provided on the base bottom wall circumferentially around the communication hole,
a second limiting portion is provided on the accommodation bottom wall circumferentially around the sound transmission hole, and
the first limiting portion and the second limiting portion engage with and abut against each other to form a third gap.

13. The earphone of claim 12, further comprising a third sealing member for sealing the third gap, wherein the third sealing member is formed by providing the fluid sealing material to the third gap and curing the fluid sealing material, and
the first limiting portion and the second limiting portion engage with and abut against each other to prevent the fluid sealing material from flowing into the sound transmission hole.

14. The earphone of claim 12, wherein
the first limiting portion comprises a groove provided on the base and arranged circumferentially around the communication hole, and
the second limiting portion comprises a corresponding protrusion provided on the accommodation bottom wall and arranged circumferentially around the sound transmission hole.

15. The earphone of claim 8, wherein
the circuit board extends over a target segment of the accommodation side wall and is connected to a flexible circuit board,
the target segment of the accommodation side wall has a smoother design compared to other portions of the accommodation side wall to reduce bending of the circuit board caused by the accommodation side wall.

16. The earphone of claim 15, wherein the target segment comprises a guiding opening formed on the accommodation side wall and an inclined guiding surface, and the guiding opening is connected to the inner wall of the housing via the guiding surface to support the circuit board.

17. The earphone of claim 1, wherein for each of the at least one sound transmission hole, an aperture of the sound transmission hole on the inner wall of the housing is less than or equal to an aperture of the sound transmission hole on an outer wall of the housing.

18. The earphone of claim 1, wherein a central axis of each of the at least one sound transmission hole is inclined relative to the accommodation bottom wall of the corresponding accommodation cavity.

19. The earphone of claim 18, wherein an inclination angle of the central axis relative to the accommodation bottom wall is in a range of [30, 90) degrees.

20. The earphone of claim 1, wherein the waterproof assembly includes a waterproof membrane and one or more buffer members, the one or more buffer members abut against an edge region of the waterproof membrane.
